(19) United States
(12) Patent Application Publication
(10) Pub. No.: US 2007/0257405 A1
(43) Pub. Date: Nov. 8, 2007

(54) Method and a Device for Expanding a Body Under Overpressure

(75) Inventor: Rune Freyer, Stavanger (NO)

Correspondence Address: SMITH IP SERVICES, P.C., P.O. Box 997, Rockwall, TX, 75087, US

(73) Assignee: EASY WELL SOLUTIONS AS, Stavanger (NO)

(21) Appl. No.: 11/596,571

(22) PCT Filed: May 23, 2005
(86) PCT No.: PCT/NO05/00170

§ 371 Date: Jan. 10, 2007

(30) Foreign Application Priority Data
May 25, 2004 (NO) 20042134

(51) Int. Cl. B29C 67/20

(52) U.S. Cl. 264/570; 428/542.8

(57) ABSTRACT

A method and a device for expanding a body (10, 22) under overpressure, in which the body (10, 22) which is formed of a material (12, 24) with a considerable portion of cavities, and which is compressed when being placed in an area of overpressure, is expanded by the cavities filling with fluid.

This invention relates to a method for expanding a body under overpressure. More particularly, it concerns the expansion of a body that is made of an elastic material having a considerable portion of closed cavities, the material allowing the diffusion of a fluid through the material and into the cavities. The method is particularly suitable for operations in the ground, in which a body of this kind, when it is being lowered to the desired position, is compressed by the prevailing overpressure, after which a fluid diffuses, over some time, through the material and into the cavities. Alternatively, the cavities are open and are held in compression during insertion into an area of elevated pressure. The invention also includes a device for practicing the method.

Bodies of this kind may have a number of applications, for example as an annular packer in an underground well. In this description, to illustrate the operation, such an application has been taken as the starting-point. The example does not in any way limit the use of the body to this example.

Completing a petroleum well by means of a sand screen in an open hole is a simple and reliable method for completing a reservoir section. A petroleum well normally penetrates formations of varying production properties. These different properties may lead to undesired well fluid of an area flowing in through the sand screen and further into the production pipe.

It may thus be desirable to close off an area to the inflow of fluid. This closing off must take place in the annulus between the sand screen and the well hole.

According to the prior art, such closing off is effected for example by means of inflatable annular packers which are placed at a desirable location, and which are then activated by means of relatively complicated equipment. It has sometimes turned out to be difficult to achieve pressure tightness by the use of packers of this kind.

NO patent 312478 discloses a packer which is made of a swellable material. After the packer has been placed at a desired location, the material of the packer absorbs a fluid and thereby swells until it seals the annulus. In some wells, for example when dry gas is produced, it can be difficult to achieve sufficient swelling of the packer material.

The invention has as its object to remedy the drawbacks of the prior art.

The object is realized in accordance with the invention through the features specified in the description below and in the following Claims.

By placing a body which is made of an elastic material with a considerable portion of closed cavities, the material allowing the diffusion of a fluid through the material into the cavities, in an area where overpressure is prevailing, the material will be compressed, in particular through reduction of the volume of the cavities and thereby that of the material.

Over time a surrounding fluid diffuses through the material into the cavities, whereby the body expands into its essentially original dimension, possibly until it is prevented from further expansion by adjacent bodies.

Alternatively, the elastic material may be formed with many open cavities, the material being kept in compression, for example by means of a compressing material, so that the cavities are at least partially compressed during insertion of the material into an area of elevated pressure. After the material has been placed in the area in question, the material is released from its compressed state, whereby fluid flows into the cavities of the material. The material thereby expands to its essentially original size.

Bodies of this kind are suitable for application also in water wells and dry gas wells, in which swelling materials are usable only to a limited degree.

In what follows is described a non-limiting example of a preferred method and embodiment which are visualized in the accompanying drawings, in which:

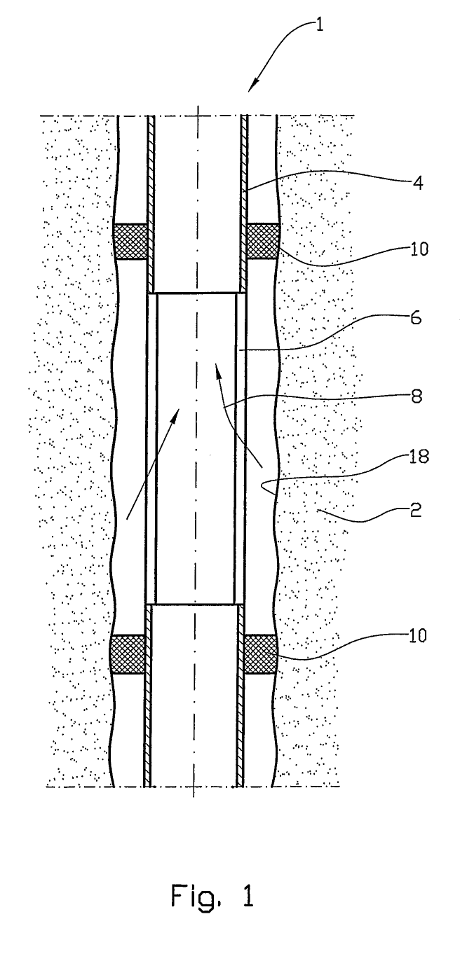

FIG. 1 shows a production pipe with a sand screen in an underground well, in which there are arranged annular packers according to the invention to limit the admission area of the sand screen;

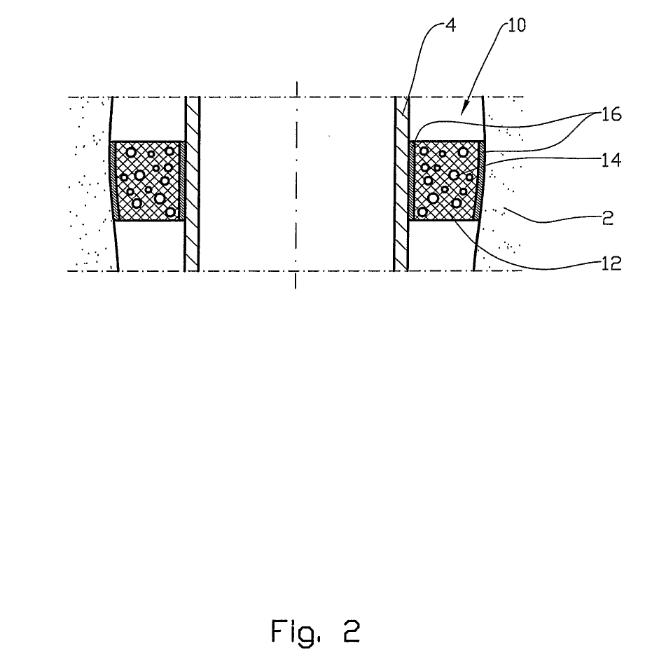

FIG. 2 shows, on a larger scale, a section of FIG. 1;

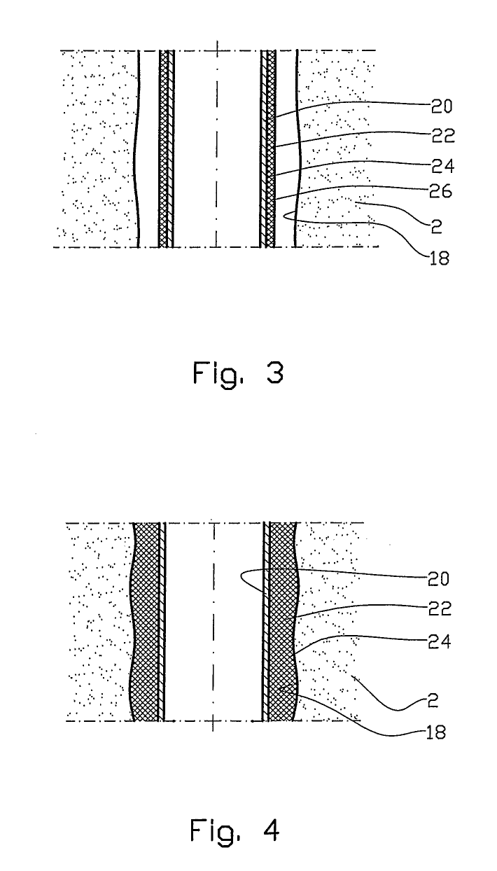

FIG. 3 shows an expandable pipe which is provided externally with a sleeve of compressed expandable material before expansion has taken place; and

FIG. 4 shows the same pipe as FIG. 3 after the expansion of the expandable pipe and material has taken place.

In the drawings the reference numeral 1 identifies an underground well in a reservoir formation 2. A production pipe 4 including a sand screen 6 is placed in the underground well 1. Well fluid, indicated in FIG. 1 by arrows 8, flows from the reservoir formation 2 into the production pipe 4 through the sand screen 6. The underground well 1 forms an area of overpressure due to the height of the fluid column of the well.

In order to shut off the inflow of fluid into the production pipe 4 from adjacent areas, annular packers 10 have been set.

The annular packers 10, see FIG. 2, are made of an elastic material 12 with a considerable portion of closed cavities 14, the material allowing the diffusion of a fluid through the material 12 into the cavities 14. The material 12 may be nitrile rubber, for example. The material 12 may be provided with one or more reinforcements 16, for example in the form of fibre cloth.

The annular packer 10 is formed with a somewhat larger transverse dimension than the transverse dimension of the opening which it is to fill. When the annular packer 10 is run into the underground well 1, the cavities 14 of the material are compressed due to an increasing static pressure. Thereby, the annular packer 10 can easily be moved forward into the desired position.

The diffusion of fluid through the material 12 into the cavities 14 of the material 12 will start immediately. The cavities 14 are thereby filled, so that the pressure within the cavities 14 will be approximately equal to the prevailing pressure at the annular packer 10. Thereby, the annular packer 10 will attempt to adopt its original shape. If the diameter of the underground well is smaller than the original diameter of the annular packer 10, the annular packer 10 will tighten against the formation wall 18 of the underground well 1, alternatively against a casing, not shown, if the underground well 1 is cased.

In an alternative embodiment, see FIGS. 3 and 4, an expandable pipe 20 is provided with an encircling sleeve 22 of a material 24 which has open pore-like cavities. Before insertion into the underground well 1, the material 24 of the sleeve 22 is compressed by means of an encircling preloading material 26. The preloading material 26 may be formed by, for example, a fibre cloth.

After the expandable pipe 20 has been placed in a desired position, the expandable pipe 20 is expanded, whereby the preloading material 26 bursts.

The expansion of the sleeve 22 then takes place by fluid flowing into the cavities of the material 24, whereby the sleeve 22 is expanded into its original shape.

1-6. (canceled)

7. A method for expanding a body (10, 22) under overpressure where the body (10, 22) is formed of an elastic material (12, 24) with a considerable portion of closed cavities (14), and where the body (10, 22) when being placed in an area (1) of overpressure is compressed, characterized in that the body (10, 22) is expanded by diffusion of fluid present at the body (10, 22) through the elastic material (12) and into the cavities (14).

8. A method in accordance with claim 7, characterized in that the body (10, 22) when placed in the area (1) of overpressure is compressed by the acting pressure.

9. A method in accordance with claim 7, characterized in that the body (10, 22) is compressed by a preloading material (26) before the body (10, 22) is placed in an area (1) of overpressure.

10. A device of an expandable body (10, 22) where the body (10, 22) is formed of an elastic material (12, 24) with a considerable portion of closed cavities, and which is placed, in the compressed form, in an area of overpressure, characterized in that the body (10, 22) is made of a diffusable material.
